(19) United States
(12) Patent Application Publication
(10) Pub. No.: US 2010/0319033 A1
(43) Pub. Date: Dec. 16, 2010

(54) Apparatus And Method For Supporting Multiple Services

(75) Inventors: Tommi Juhani Auranen, Turku (FI); Petri Vasenkari, Turku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/484,705

(22) Filed: Jun. 15, 2009

(51) Int. Cl. H04N 7/16

(52) U.S. Cl. 725/62; 725/126

(57) ABSTRACT

In accordance with an example embodiment of the present invention, a method is disclosed that comprises receiving a first signaling message from a transmitting station indicating a burst reception timing on a broadcast receiving channel; sending a second signaling message to a coupled base station including the burst reception timing; receiving a resource allocation message from the coupled base station; and allocating a time slot for a transmitting channel based at least in part on the resource allocation message in such a way that transmitting data on the allocated transmitting channel during the allocated time slot does not interfere with receiving data on the broadcast receiving channel.

### TECHNICAL FIELD

The present application relates generally to an apparatus and a method for supporting multiple services.

### BACKGROUND

New generation of wireless user equipment (UE) may support new services such as mobile television (TV) and long term evolution (LTE) cellular radio services at the same time. For example, the UE may allow a user to record a TV program during a voice call or allow the user to browse web while watching TV on a UE. Examples of LTE services may include voice call with various call features and various data services. However, this might cause interference between frequency channels allocated for the differences services. Frequency bands are scarce resources and the allocated frequency bands for the application such as mobile TV services and LTE services may be very close to each other without any or with very narrow guard bands to separate the channels.

The UE may support not only the mobile TV service, but also multiple technologies or types of mobile TV services. Example mobile TV technologies may include media forward link only (mediaFLO), digital video broadcast-handheld (DVB-H), DVB-H2, and digital multimedia broadcasting (DMB). Different mobile TV technologies may use different frequency bands.

### SUMMARY

Various aspects of the invention are set out in the claims.

In accordance with an example embodiment of the present invention, a method comprises receiving a first signaling message from a transmitting station indicating a burst reception timing on a broadcast receiving channel; sending a second signaling message to a coupled base station including the burst reception timing; receiving a resource allocation message from the coupled base station; and allocating a time slot for a transmitting channel based at least in part on the resource allocation message in such a way that transmitting data on the allocated transmitting channel during the allocated time slot does not interfere with receiving data on the broadcast receiving channel.

In accordance with an example embodiment of the present invention, an apparatus comprises a broadcast receiver configured to: receive a first signaling message from a transmitting station indicating a burst reception timing on a broadcast receiving channel; and receive a broadcast burst transmission; a transceiver configured to: transmit to a coupled base station a second signaling message including the burst reception timing; and receive a resource allocation message from the coupled base station; and an interworking module configured to allocate a time slot for a transmitting channel according to the resource allocation message from the coupled base station in such a way that transmitting data on the transmitting channel during the allocated time slot does not interfere with receiving data on the broadcast receiving channel.

In accordance with another example embodiment of the present invention, an apparatus comprises a transceiver configured to receive a signaling message from a user equipment (UE) indicating a burst reception timing on a broadcast receiving channel of the UE; and a scheduler configured to allocate a time slot for a transmitting channel of the UE in such a way that transmitting data by the UE on the allocated transmitting channel during the allocated time slot does not interfere with receiving data by the UE on the broadcast receiving channel.

### BRIEF DESCRIPTION OF DRAWINGS

For a more complete understanding of example embodiments of the present invention, reference is now made to the following descriptions taken in connection with the accompanying drawings in which:

FIG. 1 illustrates an example wireless system supporting multiple services.

FIG. 2A illustrates an example frequency band allocation.

FIG. 2B illustrates an example burst reception timing pattern.

FIG. 3 illustrates an example method for support of multiple services at a UE.

FIG. 4 illustrates an example apparatus for support of multiple services at the UE.

FIG. 5 illustrates an example method for support of multiple services at a base station.

FIG. 6 illustrates an example wireless apparatus.

### DETAILED DESCRIPTION

When a service, for example mobile TV, is supported on a LTE UE, there might be interferences between the service and another service to support both the mobile TV service and the LTE services. Because of a lack of guard frequency band, the solution in frequency domain may not be practical. One solution is to use resource allocation in such a way that the interference from the existing service to the new service is avoided in time domain if possible or reduced to an acceptable level if the interference avoidance is not practical.

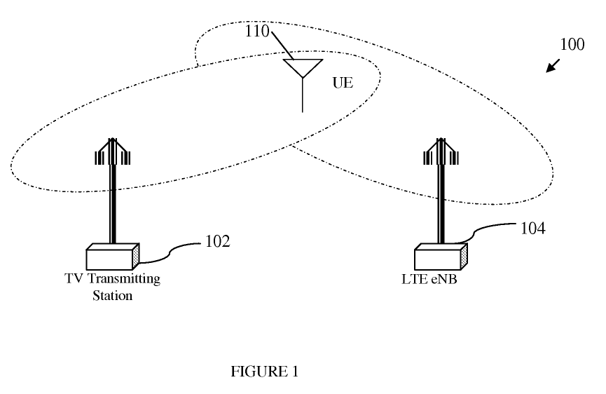

An example embodiment of the present invention and its potential advantages are best understood by referring to FIGS. 1 through 5 of the drawings, like numerals being used for like and corresponding parts of the various drawings.

FIG. 1 illustrates an example wireless system 100 that may support multiple services, including the mobile TV service. The wireless system 100 of FIG. 1 includes a UE 110 and multiple stations, for example a TV transmitting station 102, and LTE base station evolution Node B (eNB) 104. The UE 110 is within the range of both the TV transmitting station 102 and the LTE base station 104 and thus may have both mobile TV services and LTE services.

The wireless system 100 illustrates an example of mobile TV service and LTE services. In an example embodiment, mobile TV service is based on the MediaFLO standard, the DBV-H standard, or both. When the UE 110 has both an LTE services and the mobile TV service active at the same time, the LTE voice call may interfere with reception of the mobile TV signals, because the radio frequencies allocated to the voice channel and the TV broadcast receiving channel may be adjacent or close to each other. In one embodiment, the UE 110 may receive a signaling message from the mobile TV transmitting station 102 to indicate a burst reception timing and then forward the signaling message onto the LTE base station 104. Once the mobile TV burst reception timing is known, the LTE base station eNB 104 may allocate a transmitting channel to the UE 102 in such a way that the time slot to the UE 104 for transmitting the voice call data may avoid overlapping the time slot for receiving the mobile TV burst transmission. In another embodiment, it may be impractical to avoid any interference from the voice call to receiving data on the mobile broadcast receiving channel in the UE 110. In this case, the UE 102 may inform the eNB 104 of an acceptable interference level and the eNB 104 may allocate a time slot for the voice data transmitting channel in such a way that the interference from the voice data channel to the mobile TV reception is controlled within the acceptable level.

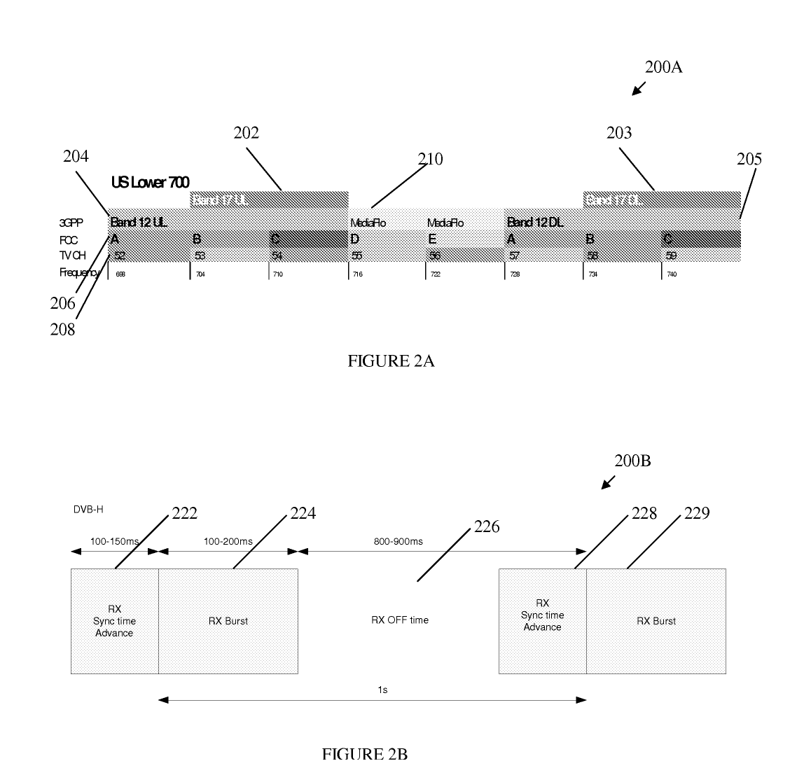

FIG. 2A illustrates an example frequency band allocation 200A. The example frequency band allocation 200A includes standard 3GPP LTE frequency bands, US Federal Communication Commissions (FCC) granted frequency bands 206, and standard TV channel frequency bands 208. The 3GPP LTE standard bands includes band 12 and band 17. The example frequency band allocation 200A shows a LTE band 17 uplink portion 202 and the downlink portion 203, and the band 12 uplink portion 204 and the downlink portion 205. The band 17 uplink portion 202 ranges from 704 MHz to 716 MHz, and the downlink portion 203 from 734 MHz to 750 MHz. The LTE band 12 uplink portion 204 ranges from 698 MHz to 716 MHz and the downlink portion 205 from 728 MHz to 750 MHz. In between is a frequency band 210 ranging from 716 MHz to 728 MHz allocated to mobile TV MediFLO. The FCC allocated frequency band 206 includes a set of five TV channels enumerated A through E corresponding to TV channels numbered from channel 52 to channel 59.

FIG. 200A shows that the LTE frequency bands 202 and 204 be adjacent to other services such as mobile TV frequency bands MediaFLO 210, without a guard band. When a UE supports both LTE services and the mobile TV service, different services may interfere with each other. For example, when an LTE uplink channel in the frequency region 716 is in use for transmitting voice call data, it may interfere with receiving data on a broadcast receiving channel using the MediaFLO frequency band 210, because of the close proximity of the two channels. One solution to the interference issue may be to allocate a time slot for a frequency channel in LTE band 12 or band 17 in such a way that the time slot either avoids overlapping the time slot for MediaFLO burst reception or overlaps only to the extent that the resulting interference is within an acceptable level.

FIG. 2B illustrates an example burst reception timing pattern 200B. The broadcast burst reception timing pattern 200B includes a receiving synchronization time advance 222, a burst reception ON period 224, and a burst reception OFF period 226. The receiving synchronization time advance time slot 222 of about 100-150 milliseconds (ms) is for various preparation steps for burst data reception time slot 224. The preparation steps includes radio frequency (RF) part frequency synthesis stabilization, orthogonal frequency-division multiplexing (OFDM) demodulator synchronization loop stabilization, gain control stabilization, channel estimation filter buffer filling, and the like. After the preparation steps, the UE may enter the time slot 224 for receiving burst data for about 100 to 200 ms. After the burst reception period, there is a burst reception OFF period for about 800 to 900 ms. During this OFF period, the UE may be allowed to transmit data for LTE services such as voice call to avoid overlapping the time slot for mobile TV broadcast burst reception. The timing pattern of receiving synchronization time advance, the burst reception ON period and burst reception OFF period may be repeated.

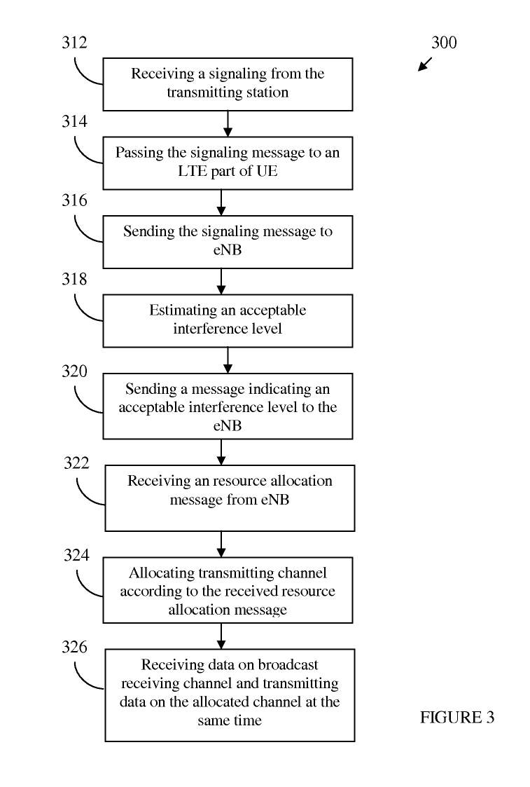

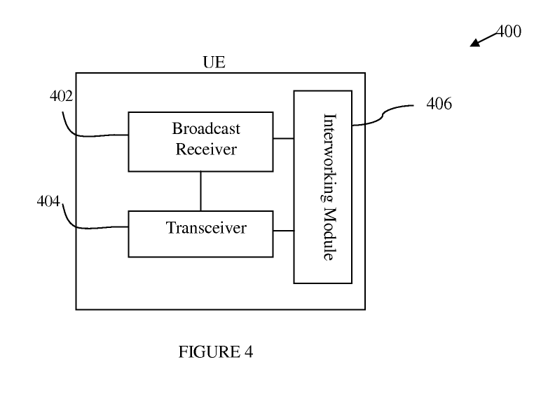

FIG. 3 illustrates an example method 300 for support of multiple services at a UE. The method 300 includes receiving a signaling message from the broadcast transmitting station at block 312, passing the signaling message to the LTE part of the UE at block 314, and sending the signaling message to the LTE base station eNB at block 316. The method 300 also includes estimating an acceptable interference level at block 318, sending a signaling message indicating the acceptable interference level to the eNB at block 320, and receiving a resource allocation message from the eNB at block 322. The method 300 also includes allocating a transmitting channel according to the received resource allocation message at block 324, and receiving data on the broadcast receiving channel and transmitting data on the allocated transmitting channel at the same time at block 326. In one embodiment, the method 300 may be implemented in the UE 110 of FIG. 1 or in the wireless apparatus 400 of FIG. 4. The method 300 is for illustration only and the method 300 may be arranged in a different sequence without departing from the scope of the invention of this example embodiment.

Receiving a signaling message from the broadcast transmitting station at block 312 includes receiving a signaling message from a mobile TV transmitting station such as Mediaflow or DVB-H mobile TV transmitting station by a broadcast receiver at the UE. The signaling message may inform the UE of the broadcast burst reception timing. The burst reception timing include information related to a burst reception time slot such as burst reception start time, a burst reception duration, a burst reception interval and the like. Optionally the signaling message may include a broadcast reception synchronization time advance and the contents of the broadcast reception synchronization time advance may vary from one mobile TV standard to another. In one example embodiment, the reception synchronization time advance includes a radio frequency (RF) part frequency synthesis stabilization, an OFDM demodulator synchronization loop stabilization, a gain control stabilization, a channel estimation filter buffer filling, and the like.

Passing the signaling message to the LTE part of the UE at block 314 may include sending an internal message within the UE from the broadcast receiver to an LTE part of the UE to inform the UE of the burst reception timing. The UE may have at least a broadcast receiver part and a LTE transceiver part as shown in FIG. 4. Sending the signaling message to the LTE base station eNB at block 316 may include using an existing LTE signaling message or a new signaling message to send the burst reception timing information to the coupled base station. Alternatively, the burst reception timing information may be piggybacked on another LTE signaling message between the UE and LTE eNB.

Estimating an acceptable interference level at block 318 may include taking into consideration the factors such as an inner modulation in the transmission, code rates used for the error correction, a code rate for Reed Solomon encoding scheme, a symbol duration, a length of cyclic prefix of the transmitting channel and the like. The examples of the inner modulation may include quadrature phase shift keying (QPSK), 16 quadrature amplitude modulation (16 QAM) or 64 QAM. The examples of code rate for error correction include rate of ½, ⅔ or ¾ for convolutional coding, Turbo coding or low-density parity-check code (LDPC) coding. Examples of code rate for ReedSolomon include Multiprotocol Encapsulation—Forward Error Correction (MPE-FEC) in DVB-H, block Reed Solomon in MediaFLO. The symbol duration may be set by OFDM Fast Fourier Transform (FFT) size, and example of cyclic prefix may include guard interval of DVB-H. The acceptance interference level may be represented in variety of ways. The examples may include an error data rate, and a redundancy data rate. The redundancy data rate may represent a rate at which the data need to be resent as result of data errors.

Sending a signaling message indicating the acceptable interference level to the LTE base station eNB at block 320 may include sending a separate signaling message containing the acceptable interference level for the UE. Alternatively, one signaling message may be used to send both the acceptable interference level and the broadcast burst reception timing.

Receiving a resource allocation message at block 322 may include receiving a message from the coupled LTE eNB to allocate a time slot for a transmitting data for a LTE service such as a voice call. The resource allocation message may be an independent message by itself or a part of another signaling message. The resource allocation message may designate a time slot for a transmitting channel that avoids overlapping the time slot of the burst reception timing. Alternatively, the designated time slot may partially overlaps the time slot for the broadcast receiving channel to the extent that the interference generated from transmitting data on the allocated transmitting channel during the allocated time slot is within the acceptable interference level. Allocating resource according to the received resource allocation message at block 324 may include actually allocating a time slot for the transmitting channel as commended by the eNB and updating the UE's local available resource map.

Receiving data on the broadcast receiving channel and transmitting data on the allocated transmitting channel at the same time at block 326 may include receiving mobile TV broadcast data and sending data for another service such as a voice call at the same time. The interference from the transmitting voice data on the transmitting channel either does not affect receiving mobile TV broadcast data or affect only to an extent that is within the acceptable interference level.

FIG. 4 illustrates an example apparatus 400 for support of multiple services at the UE. The apparatus 400 includes at least a broadcast receiver 402, a transceiver 404, and an interworking module 406. The broadcast receiver 402 may send a received signaling message to the interworking module 406 for processing and to the transceiver 404 to be forwarded to the coupled eNB. The broadcast receiver 402 may be configured to receive a signaling message from a transmitting station indicating a burst reception timing on a broadcast receiving channel. The transceiver 404 may be a LTE transceiver configured to transmit to a coupled base station such as LTE eNB application data and a signaling messages including the burst reception timing. The LTE transceiver may also configured to receive application data in a bidirectional communication and a resource allocation message from the coupled base station.

The interworking module 406 may be configured to enable interworking of multiple services. In one embodiment, the interworking module 406 may be configured to allocate a transmitting channel as commanded by the base station in such a way that transmitting data on the transmitting channel does not interfere with receiving data on the broadcast receiving channel. The interworking module 406 may be further configured to determine an acceptable interference level of transmitting data on the transmitting channel for the broadcast receiving channel in terms of a data redundancy rate. In addition, the interworking module 406 may be configured to send the acceptable interference level to the coupled base station, and to allocate the transmitting channel at the UE according to the resource allocation message in such a way that the interference of transmitting data on the transmitting channel to the broadcast receiving channel is within the acceptable interference level.

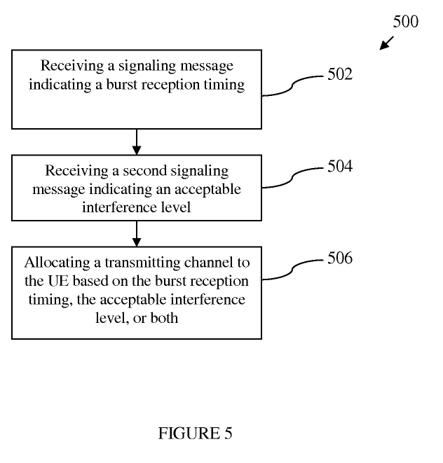

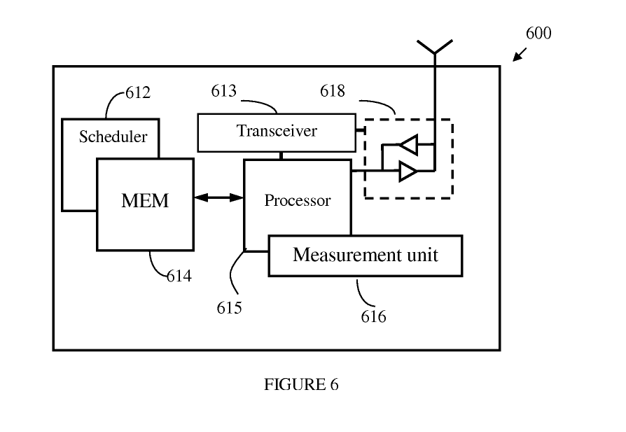

FIG. 5 illustrates an example method 500 for support of multiple services at a base station such as a LTE eNB. The method 500 includes receiving a signaling message indicating a burst reception timing at block 502, receiving a second signaling message indicating an acceptable interference level at block 504, and allocating a transmitting channel to the UE based on the burst reception timing, the acceptable interference level, or both at 506. In one embodiment, the method 500 may be implemented in the eNB 104 of FIG. 1 or in the wireless apparatus 600 of FIG. 6. The method 500 is for illustration only and the method 500 may be arranged in a different sequence without departing from the scope of the invention of this example embodiment.

Receiving a signaling message indicating a burst reception timing at block 502 may include receiving a message from the coupled UE to indicate a time slot during which the UE is scheduled to receive broadcast burst transmission from a mobile TV transmitting tower. Receiving a second signaling message indicating an acceptable interference level at block 504 may include receiving another signaling message from the UE indicating the acceptable interference level that the UE may tolerate in receiving broadcast burst transmission. Alternatively, the second signaling message may be part of the first signaling message.

Allocating a transmitting channel at block 506 may include allocating a transmitting channel to the UE, according to the burst reception timing information, the acceptable interference level, or both. In one embodiment, the eNB may first consider to allocate a time slot to the UE for the transmitting channel that may avoid overlapping the time slot of the broadcast burst reception. In this way, any interference from transmitting data on the transmitting channel to the broadcast receiving channel may be avoided. In some cases, due to resource constraints, the eNB may not be able to allocate such a time slot to avoid interference to the broadcast receiving channel. The eNB may consider allocating a transmitting channel to the UE in such as way that the interference from transmitting data on the transmitting channel to receiving broadcast burst transmission is within the specified acceptable interference level. The acceptable interference level may be specified in terms of redundancy data rate, or the redundancy data as percentage of total transmitted data.

FIG. 6 illustrates a simplified block diagram of an exemplary wireless device that is suitable for use in practicing the example embodiments of at least part of this invention. In FIG. 6, the device 600 may include a processor 615, a memory 614 coupled to the processor 615, and a suitable transceiver 613 (having a transmitter (TX) and a receiver (RX)) coupled to the processor 615, coupled to an antenna unit 618. The memory 614 may store programs such as a resource scheduler 612.

The processor 615 or some other form of generic central processing unit (CPU) or special-purpose processor such as digital signal processor (DSP), may operate to control the various components of the wireless device 600 in accordance with embedded software or firmware stored in memory 614 or stored in memory contained within the processor 615 itself. In addition to the embedded software or firmware, the processor 615 may execute other applications or application modules stored in the memory 614 or made available via wireless network communications. The application software may comprise a compiled set of machine-readable instructions that configures the processor 615 to provide the desired functionality, or the application software may be high-level software instructions to be processed by an interpreter or compiler to indirectly configure the processor 615.

The transceiver 613 is for bidirectional wireless communications with another wireless device. The transceiver 613 may provide frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. For the purposes of clarity, the description here separates the description of this signal processing from the RF and/or radio stage and conceptually allocates that signal processing to some analog baseband processing unit and/or the processor 615 or other central processing unit. In some embodiments, the transceiver 613, portions of the antenna unit 618, and an analog baseband processing unit may be combined in one or more processing units and/or application specific integrated circuits (ASICs).

The antenna unit 618 may be provided to convert between wireless signals and electrical signals, enabling the wireless device 600 to send and receive information from a cellular network or some other available wireless communications network or from a peer wireless device. In an embodiment, the antenna unit 618 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna unit 618 may include antenna tuning and/or impedance matching components, RF power amplifiers, and/or low noise amplifiers.

As shown in FIG. 6, the device 600 may further include a measurement unit 616, which measures the signal strength level that is received from another wireless device, and compare the measurements with a configured threshold. The measurement unit may be utilized by the device 600 in conjunction with various exemplary embodiments of the invention, as described herein. The scheduler 612 may be configured to allocate a transmitting channel to the UE in such a way that transmitting data by the UE on the allocated transmitting channel does not interfere with receiving data by the UE on the broadcast receiving channel. Alternatively the scheduler 612 may also be configured to allocate the transmitting channel to the UE in such a way that the interference from transmitting data on the allocated transmitting channel to the broadcast receiving channel of the UE is within the acceptable interference level.

In general, the various example embodiments of the device 600 may include, but are not limited to, part of a base station, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Without in any way limiting the scope, interpretation, or application of the claims appearing below, a technical effect of one or more of the example embodiments disclosed herein may be a method and an apparatus for support of multiple services including the mobile TV service that are configured to avoid or minimize interferences between the mobile TV service and other services.

Embodiments of the present invention may be implemented in software, hardware, application logic or a combination of software, hardware and application logic. The software, application logic and/or hardware may reside on a mobile station or user equipment, a base station or other mobile computing device. If desired, part of the software, application logic and/or hardware may reside on a mobile station, part of the software, application logic and/or hardware may reside on a base station, and part of the software, application logic and/or hardware may reside on a second mobile station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. A method, comprising:
receiving a first signaling message from a transmitting station indicating a burst reception timing on a broadcast receiving channel;
sending a second signaling message to a coupled base station including the burst reception timing;
receiving a resource allocation message from the coupled base station; and
allocating a time slot for a transmitting channel based at least in part on the resource allocation message in such a way that transmitting data on the allocated transmitting channel during the allocated time slot does not interfere with receiving data on the broadcast receiving channel.

2. The method of claim 1, wherein the allocated time slot for the transmitting channel does not overlap time slot in the burst reception timing for the broadcast receiving channel.

3. The method of claim 1, further comprising:
determining an acceptable interference level of transmitting data on the transmitting channel for the broadcast receiving channel during the burst reception timing in terms of a data redundancy rate;
sending the acceptable interference level to the coupled base station; and
allocating the transmitting channel in such a way that the interference of transmitting data on the transmitting channel for the broadcast receiving channel is within the acceptable interference level.

4. The method of claim 3, wherein determining the acceptable interference level comprises considering at least one of a modulation scheme, an interleaving scheme, a coding scheme and a reception power level of the broadcast receiving channel and determining the data redundancy rate in terms of the redundancy data as a percentage of total transmission data.

5. The method of claim 4, wherein allocating the transmitting channel comprises allocating a time slot for the transmitting channel that partially overlaps a time slot in the burst reception timing for the broadcast receiving channel in such a way that the interference of transmitting data during the time slot for the transmitting channel to the broadcast receiving channel is within the acceptable interference level.

6. The method of claim 5, wherein the burst reception timing comprises at least one time slot for burst reception indicated by at least one of a burst reception start time, a burst reception duration, and a burst reception interval.

7. The method of claim 6, wherein receiving the first signaling message further comprises receiving a synchronization time advance that comprises at least one of a radio frequency (RF) part frequency synthesis stabilization, orthogonal frequency-division multiplexing (OFDM) demodulator synchronization loop stabilization, gain control stabilization, and channel estimation filter buffer filling.

8. The method of claim 1, further comprising
sending data on the allocated transmitting channel and receiving broadcast burst transmission at the same time.

9. An apparatus, comprising:
a broadcast receiver configured to:
receive a first signaling message from a transmitting station indicating a burst reception timing on a broadcast receiving channel; and
receive a broadcast burst transmission;
a transceiver configured to:
transmit to a coupled base station a second signaling message including the burst reception timing; and
receive a resource allocation message from the coupled base station; and
an interworking module configured to:
allocate a time slot for a transmitting channel according to the resource allocation message from the coupled base station in such a way that transmitting data on the transmitting channel during the allocated time slot does not interfere with receiving data on the broadcast receiving channel.

10. The apparatus of claim 9, wherein the interworking module is further configured:
to determine an acceptable interference level of transmitting data on the transmitting channel for the broadcast receiving channel in terms of a data redundancy rate; and
to send the acceptable interference level to the coupled base station.

11. The apparatus of claim 10, wherein the interworking module is further configured to allocate the time slot for the transmitting channel according to the resource allocation message in such a way that the interference of transmitting data on the transmitting channel during the allocated time slot to the broadcast receiving channel is within the acceptable interference level.

12. The apparatus of claim 9, wherein the apparatus is one of a LTE user equipment (UE), a WiMax UE, and a 4^{th} generation wireless UE.

13. The apparatus of claim 9, wherein the broadcast receiver is configured to receive TV broadcast signals in compliance with one of a MediaFLO transmission standard and a DVB-H transmission standard.

14. The apparatus of claim 9, wherein the apparatus is configured to transmit data on the allocated transmitting channel and to receive broadcast burst transmission at a same time.

15. An apparatus, comprising:
a transceiver configured
to receive a signaling message from a user equipment (UE) indicating a burst reception timing on a broadcast receiving channel of the UE; and
a scheduler configured
to allocate a time slot for a transmitting channel of the UE in such a way that transmitting data by the UE on the allocated transmitting channel during the allocated time slot does not interfere with receiving data by the UE on the broadcast receiving channel.

16. The apparatus of claim 15, wherein the signaling message from the UE further indicates an acceptable interference level in terms of a redundancy data rate.

17. The apparatus of claim 16, wherein the scheduler is further configured to allocate the time slot for the transmitting channel of the UE in such a way that the interference from transmitting data on the allocated transmitting channel during the time slot to the broadcast receiving channel of the UE is within the acceptable interference level.

18. The apparatus of claim 15, wherein the apparatus is one of a LTE eNB, eNB-Adanced, and a generic 4^{th} generation (4G) base station.

19. The apparatus of claim 15, wherein the transceiver is further configured:
to receive data transmitted on the allocated transmitting channel from the UE; and
to transmit data to the UE at same time.

20. The apparatus of claim 17, wherein the apparatus is coupled with one of a MediaFLO mobile TV transmitting station and a DVB-H mobile TV transmitting station.
